(19) United States
(12) Patent Application Publication
(10) Pub. No.: US 2022/0058602 A1
(43) Pub. Date: Feb. 24, 2022

(54) COMPUTERIZED SYSTEMS AND METHODS FOR A NETWORKED INFRASTRUCTURE FOR MANAGING AND CONTROLLING SUBSCRIPTION BASED SERVICES

(71) Applicant: AVEVA SOFTWARE, LLC, Lake Forest, CA (US)

(72) Inventors: John Krajewski, Lake Forest, CA (US); Alvaro Martinez, Irvine, CA (US); George Philip Bauer, III, San Juan Capistrano, CA (US)

(21) Appl. No.: 17/405,743

(22) Filed: Aug. 18, 2021

Related U.S. Application Data
(60) Provisional application No. 63/067,164, filed on Aug. 18, 2020.

(51) Int. Cl. G06Q 20/12; G06Q 20/14

(52) U.S. Cl. CPC G06Q 20/127; G06Q 10/103; G06Q 20/1235; G06Q 20/145

(57) ABSTRACT

The disclosed systems, servers and methods provide for a subscription and solution framework that provides novel mechanisms for scalable operations to be provided and/or accessible from management systems (such as, for example, asset (e.g., equipment), engineering and/or plant management systems, and the like) to apply, disseminate and/or utilize when interacting with subscribers (e.g., third party entities, users, clients, partners, and the like). The disclosed framework provides device and software agnostic integration and architectural flexibility, while maintaining and efficiently (both computationally and from a cost-basis) providing cloud-based technical support and services. The disclosed framework enables enhanced investment security and commercial flexibility, boosts production efficiency, enhances operational flexibility and eliminates pricing complexity.

### CROSS-REFERENCE TO RELATED APPLICATIONS

This application claims the benefit of priority from U.S. Provisional Application No. 63/067,164, filed Aug. 18, 2020, entitled “Flexible Financing Server System and Method,” which is incorporated herein by reference in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

Some embodiments relate generally to improving the performance of network-based computerized application, asset (e.g., equipment) management and content hosting and providing devices, systems and/or platforms by modifying the capabilities and providing non-native functionality to such devices, systems and/or platforms through a novel and improved framework for managing and controlling operations of applications, assets and services, and the data and metadata (e.g., files) created, updated and interacted with therefrom.

### BACKGROUND

As automation systems become more complex, and the costs associated with their design, development, optimization, and maintenance increase, there is a competitive pressure to offer alternative financing systems that provide customers with the flexibility they need in their operations.

### SUMMARY

The present disclosure provides a subscription and solution framework that provides novel mechanisms for scalable solutions for management systems (such as, for example, asset (e.g., equipment), engineering and/or plant management systems, and the like) to apply, disseminate and/or utilize when interacting with subscribers (e.g., third party entities, users, clients, partners, and the like). The disclosed framework provides device and software agnostic integration and architectural flexibility, while maintaining and efficiently (both computationally and from a cost-basis) providing cloud-based technical support and services. As discussed herein, the disclosed framework enables enhanced investment security and commercial flexibility, boosts production efficiency, enhances operational flexibility and eliminates pricing complexity.

Some embodiments of the disclosed systems and methods described herein can provide customers with the flexibility they need to design, build, operate, control, analyze and optimize their operations. In some embodiments, the disclosed framework provides improved software and technical flexibility providing software applications and solutions that are “sized to fit,” scalable, and provide device and software-agnostic integration capabilities.

In some embodiments, the disclosed framework provides technically based solutions that provide greater financial flexibility, lower initial cost, can enable reallocation of funds, provide a leaner balance sheet, and an improved cash flow.

According to some embodiments, as discussed below, the solutions discussed herein can be based on and/or executed as part of operations of, but not limited to, software as a service (SaaS), platform as a service (PaaS), infrastructure as a service (IaaS), desktop as a service (DaaS), mobile backend as a service (MBaaS), datacenter as a service (DCaaS), information technology management as a service (ITMaaS), and/or any other type of service realizable via known or to be known enterprise and/or cloud computing technologies.

Further, in some embodiments, the disclosed framework can provide architectural flexibility and tools, cloud and on-premise systems, hybrid architectures, unlimited supervisory server, and incremental value. In some embodiments, the disclosed framework can provide technical support and services, version updates, software support experts, version upgrades, services (e.g., sentinel), and training.

Some embodiments of the flexible financing systems and methods described herein can drive digital transformation and business agility through technical flexibility. In some embodiments, the systems can provide investment security and commercial flexibility, expand solution capability through increased architectural flexibility, production efficiency, and operational flexibility, as well as eliminate pricing complexity.

For purposes of this disclosure, reference may be generally be made to files that are created and uploaded by users, and files and tools related to applications, programs and devices, and include both data and metadata related to electronic information contained in the electronic (or digital) files. One of ordinary skill in the art would understand that such files and take any form, whether known or to be known, such as, but not limited to, electronic documents, images, text, audio, video, multi-media, software kits, scripts, program files, graphics, electronic messages, exchange files, CAD (computer-aided design) files (e.g., STEP/IFC (Standard for Exchange of Product Model Data/Industrial Foundation Classes) files, steel detail neutral files (SDNF) files, and the like), tag lists, and the like, or some combination thereof. One of ordinary skill in the art would also understand that such files can include, but are not limited to, including any type of known or to be known electronic content, including, but not limited to, images, text, graphics, multi-media, material files, drawings, geometrical exports, exchange data, SaaS data, PaaS data, IaaS data, file-transfer-protocol (FTP) data, and the like, or some combination thereof.

Thus, as discussed herein, some embodiments provide a novel framework that is configured for management, control, deployment and synchronization between devices, applications, systems and platforms both on-premises (on-prem or local devices/storage) and/or hosted on a network (e.g., a cloud platform, service or platform). In some embodiments, the disclosed systems and methods embodied and executed through the disclosed framework can be configured to replicate data between locations, which can include local and/or networked locations, such as on-premises sites and the Cloud.

In some embodiments, the disclosed framework is configured for executing and providing systems and methods that provide capabilities for: on-prem sync to the cloud, vice-versa, on-prem to on-prem, and cloud to cloud, and the like; enable ubiquitous access to the cloud from both on-prem and network devices; enable the sharing and access of data across locations, devices, networks, and users, and the like. Some embodiments also enable third party and native applications access to the cloud framework for accessing, uploading and synchronizing their data (e.g., read and write privileges) within the cloud and across endpoints.

Some embodiments are configured for both internal (e.g., AVEVA® products and services) and external services to access, store and retrieve data from the proprietary infrastructure disclosed herein. Some embodiments enable file sharing between location to location, cloud to cloud, device to device, device to cloud, cloud to device, network to network, and the like. Some embodiments also enable versioning, as discussed in more detail below, such that all changes to the shared files and/or cloud service accessed by all parties/entities are properly and timely dispersed to each user, device, platform or service.

In some embodiments, the disclosed framework can be configured to operate with and/or be configured according to any known or to be known cloud or database management architecture, infrastructure or management configuration, including, but not limited to, Blockchain, binary large object (BLOB) storage, files storage, or any other type of cloud database management system architecture, as understood by those of skill in the art. In some embodiments, such infrastructure can enable navigation of types of data related to types of services, products and/or hosting entities while providing security protocols (e.g., AVEVA® SDK) that control whether navigation to such type of data is accessible.

According to some embodiments, the storage provided by the disclosed framework can be configured to provide a scaled amount of storage per account, per location or per usage. The scaled amount can be set and can dictate how much data can be stored. In some embodiments, the scaled amount can be dynamically adjusted based on usage, and the integrity of such usage or access by the users of the account.

Some embodiments provide a method for managing and controlling operations of applications and services, and the data and metadata (e.g., files) created, updated and interacted with therefrom.

In some embodiments, the method involves, inter alia, receiving, over a network by a device, a request from a user, the request comprising information related to a set of assets operational by the user in relation to at least one jobsite; analyzing, by the device, the request, and identifying a set of software solutions for the user, the software solutions comprising executable software applications provided by the device; determining, by the device, based on the identified set of software solutions, a type of subscription for the user, the type of subscription comprising information controlling a manner that the user can access and execute each software solution; assigning, by the device, a subscription to an account of the user based on the type of subscription; monitoring, over the network by the device, execution of each software solution, and identifying usage data related to operations performed via at least a portion of the set of software solutions in accordance with the subscription; analyzing, by the device, the identified usage data; and controlling, by the device over the network, the operations performed by the user based on the analysis of the identified usage data.

In some embodiments, the method further includes: determining, based on the analysis of the identified usage data, that modifications to the subscription are required; and modifying the assigned subscription based on the identified usage data and the modification determination, wherein the control of the operations is based on the modified subscription.

In some embodiments, the determination that the modifications to the subscription are required comprises determining that the operations performed via at least a portion of the set of software solutions in accordance with the subscription are not satisfying a performance level threshold of at least one of the set of assets.

In some embodiments, the method further includes: presenting a page comprising information related to the type of subscription to the user; receiving input from the user related to the presented information; and determining the subscription based on the received input, wherein the assigned subscription is the determined subscription.

In some embodiments, the method further includes: identifying that the request indicated an automatic indication of a subscription assignment; and automatically performing the assigning without user input.

In some embodiments, the subscription assigned to an account of the user comprises information selected from a group consisting of: a term, credits, credit portfolio, user data, usage data, usage data determinations, and type of subscription, software application information.

In some embodiments, the monitoring and analysis of the usage of the software solutions comprises collecting and storing information related to the usage in an associated database.

Some embodiments provide a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device (e.g., a server(s)) cause at least one processor to perform a method, similar to a method discussed above, for managing and controlling operations of applications and services, and the data and metadata (e.g., files) created, updated and interacted with therefrom.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 is a schematic diagram illustrating an example of a network within which the systems and methods disclosed herein could be implemented according to some embodiments of the present disclosure;

FIG. 3 depicts is a schematic diagram illustrating an example of client device according to some embodiments of the present disclosure;

FIG. 4 is a block diagram illustrating components of an exemplary system according to some embodiments of the present disclosure;

FIG. 5 is a non-limiting example data flow according to some embodiments of the present disclosure;

FIG. 6A illustrates non-limiting examples of products, characteristics, and motivations according to some embodiments of the present disclosure;

FIG. 6B illustrates non-limiting examples of user personas, profiles, and associated product implementations according to some embodiments of the present disclosure;

FIG. 7 illustrates a non-limiting embodiment of a flex credit subscription system according to some embodiments of the present disclosure;

FIG. 8 illustrates subscription tier details according to some embodiments of the present disclosure;

FIG. 9 illustrates an example of flex credit use according to some embodiments of the present disclosure;

FIGS. 10-11 illustrate examples of flex credit portfolios according to some embodiments of the present disclosure;

FIGS. 12-16 illustrate examples of credit consumption models according to some embodiments of the present disclosure;

FIG. 17 illustrates an example of a quote and ordering subscription display according to some embodiments of the present disclosure;

FIG. 18 illustrates an example of a support portal according to some embodiments of the present disclosure; and

FIGS. 19-22 illustrate examples of flex credits management displays according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, Bluetooth, 802.11b/g/n, or the like. Network access technologies may enable wide area coverage for devices, such as client devices with varying degrees of mobility, for example.

In short, a wireless network may include any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

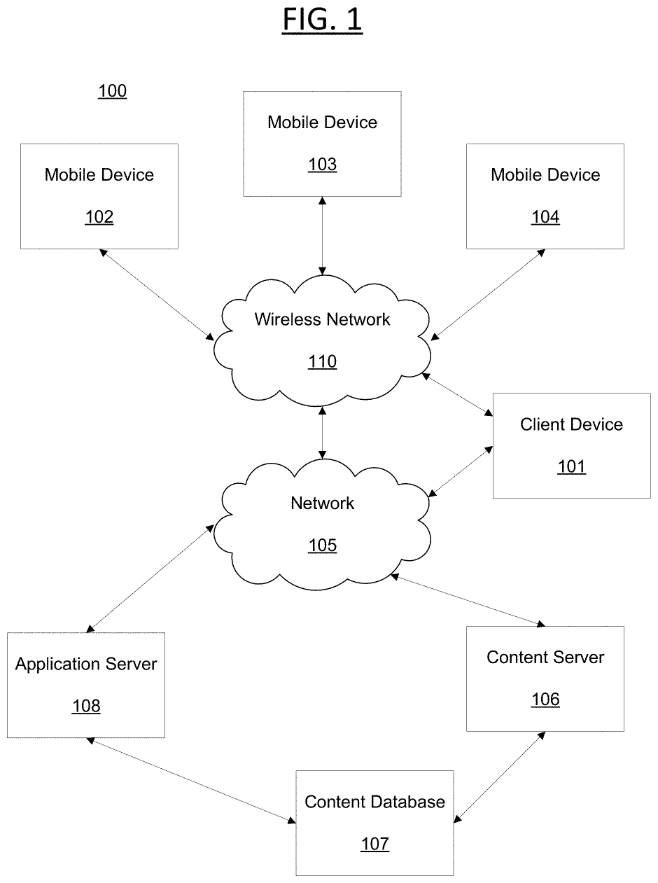

Certain embodiments will now be described in greater detail with reference to the figures. In general, with reference to FIG. 1, a system 100 in accordance with some embodiments of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106 and application (or “App”) server 108.

Some embodiments of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In some embodiments, such communications may include sending and/or receiving messages, creating and uploading documents, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

In some embodiments, wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

In some embodiments, network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

In some embodiments, the content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. In some embodiments, content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example the email services and email platform, can be provided via the message server 120.

In some embodiments, users are able to access services provided by servers 106 and 108. This may include in a non-limiting example, authentication servers, application servers, search servers, email servers, social networking services servers, SMS servers, IM servers, MMS servers, exchange servers, photo-sharing services servers, and travel services servers, via the network 105 using their various devices 101-104.

In some embodiments, application server 108, for example, can store various types of applications and application related information including application data and user profile information (e.g., identifying, generated and/or observed information associated with a user).

In some embodiments, content server 106 and app server 108 can store various types of data related to the content and services each provide, observe, identify, determine, generate, modify, retrieve and/or collect. Such data can be stored in an associated content database 107, as discussed in more detail below.

In some embodiments, server 106 and/or 108 can be embodied as a cloud server or configured for hosting cloud services, as discussed herein.

In some embodiments, the network 105 is also coupled with/connected to a Trusted Search Server (TSS) which can be utilized to render content in accordance with the embodiments discussed herein. Embodiments exist where the TSS functionality can be embodied within servers 106 and 108.

Moreover, although FIG. 1 illustrates servers 106 and 108 as single computing devices, respectively, the disclosure is not so limited. For example, one or more functions of servers 106 and 108 may be distributed across one or more distinct computing devices. Moreover, in some embodiments, servers 106 and 108 may be integrated into a single computing device, without departing from the scope of the present disclosure.

Additionally, while the illustrated embodiment in FIG. 1 depicts only servers 106 and 108, it should not be construed as limiting, as any type and number of servers can be included therein.

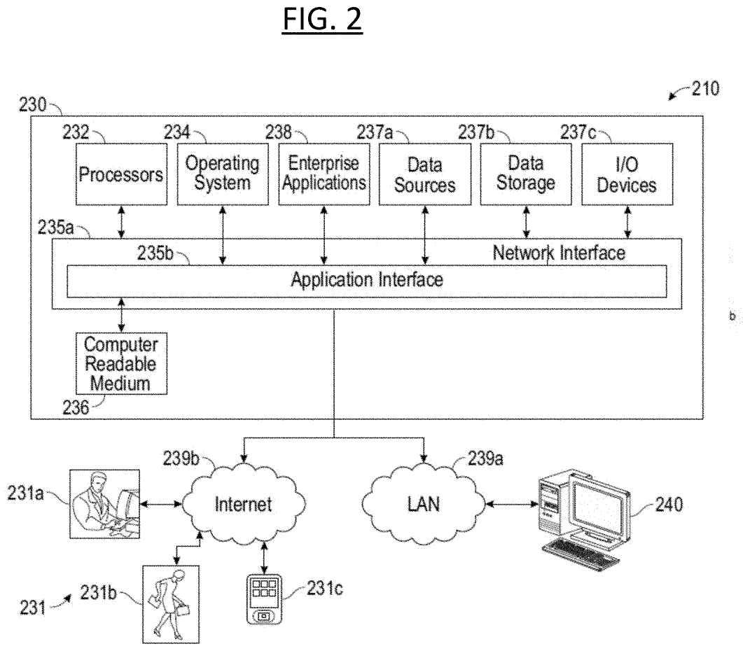

Turning to FIG. 2, computer system 210 is depicted and is a non-limiting example embodiment of system 100 discussed above in relation to FIG. 1.

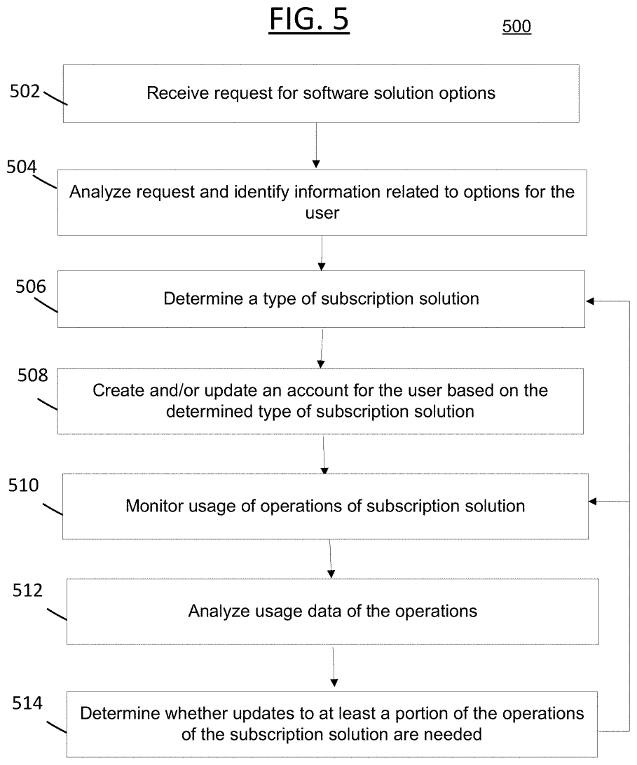

FIG. 2 illustrates a computer system 210 enabling or operating an embodiment of system 100 of FIG. 1, as discussed below (see also FIG. 5, discussed below). In some embodiments, computer system 210 can include and/or operate and/or process computer-executable code of one or more of the above-mentioned program logic, software modules, and/or systems. Further, in some embodiments, the computer system 210 can operate and/or display information within one or more graphical user interfaces. In some embodiments, the computer system 210 can comprise a cloud server and/or can be coupled to one or more cloud-based server systems.

In some embodiments, the system 210 can comprise at least one computing device 230 including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as enterprise applications). In some embodiments, the software modules 238 can include server-based software, and can operate to host at least one user account and/or at least one client account, and operating to transfer data between one or more of these accounts using the at least one processor 232.

With the above embodiments in mind, it should be understood that some embodiments can employ various computer-implemented operations involving data stored in computer systems. Moreover, the above-described databases and models described throughout can store analytical models and other data on computer-readable storage media within the system 210 and on computer-readable storage media coupled to the system 210. In addition, the above-described applications of the system can be stored on non-transitory computer-readable storage media within the system 210 and on computer-readable storage media coupled to the system 210.

In some embodiments, the system 210 can comprise at least one non-transitory computer readable medium 236 coupled to at least one data source 237a, and/or at least one data storage device 237b, and/or at least one input/output device 237c. In some embodiments, the disclosed systems and methods can be embodied as computer readable code on a computer readable medium 236. In some embodiments, the computer readable medium 236 can be any data storage device that can store data, which can thereafter be read by a computer system (such as the system 210). In some embodiments, the computer readable medium 236 can be any physical or material medium that can be used to tangibly store the desired information or data or instructions and which can be accessed by a computer or processor 232. In some embodiments, at least one of the software modules 238 can be configured within the system to output data to at least one user 231 via at least one graphical user interface rendered on at least one digital display.

In some embodiments, the non-transitory computer readable medium 236 can be distributed over a conventional computer network via the network interface 235a where the system embodied by the computer readable code can be stored and executed in a distributed fashion. For example, in some embodiments, one or more components of the system 210 can be coupled to send and/or receive data through a local area network (“LAN”) 239a and/or an internet coupled network 239b (e.g., such as a wireless internet). In some further embodiments, the networks 239a, 239b can include wide area networks (“WAN”), direct connections (e.g., through a universal serial bus port), or other forms of computer-readable media 236, or any combination thereof.

In some embodiments, components of the networks 239a, 239b can include any number of user devices such as personal computers including for example desktop computers, and/or laptop computers, or any fixed, generally non-mobile internet appliances coupled through the LAN 239a. For example, some embodiments include personal computers 240a coupled through the LAN 239a that can be configured for any type of user including an administrator. Other embodiments can include personal computers coupled through network 239b. In some further embodiments, one or more components of the system 210 can be coupled to send or receive data through an internet network (e.g., such as network 239b). For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 231a coupled to the system 210 using a desktop computer, and/or laptop computers, or any fixed, generally non-mobile internet appliances coupled through the internet 239b. In some embodiments, the user 231 can comprise a mobile user 231b coupled to the system 210. In some embodiments, the user 231b can use any mobile computing device 231c to wirelessly coupled to the system 210, including, but not limited to, personal digital assistants, and/or cellular phones, mobile phones, or smart phones, and/or pagers, and/or digital tablets, and/or fixed or mobile internet appliances.

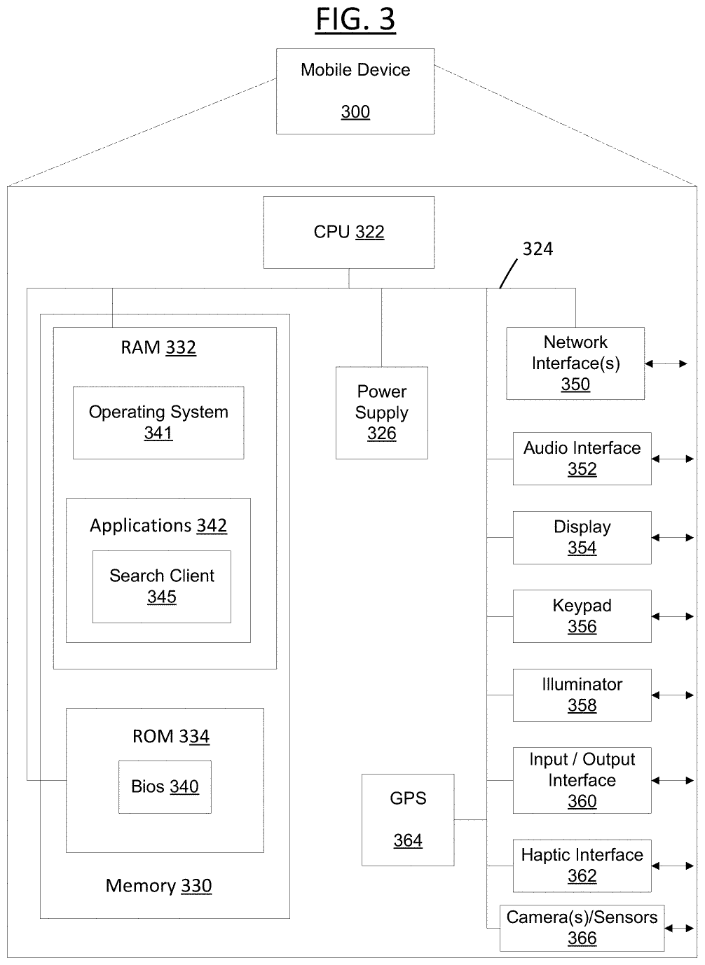

FIG. 3 is a schematic diagram illustrating a client device showing an example embodiment of a client device that may be used within the present disclosure. Client device 300 may include many more or fewer components than those shown in FIG. 3. However, the components shown are sufficient to disclose an illustrative embodiment for implementing the present disclosure. Client device 300 may represent, for example, client devices discussed above in relation to FIGS. 1-2.

As shown in FIG. 3, in some embodiments, client device 300 includes a processing unit (CPU) 322 in communication with a mass memory 330 via a bus 324. In some embodiments, client device 300 also includes a power supply 326, one or more network interfaces 350, an audio interface 352, a display 354, a keypad 356, an illuminator 358, an input/output interface 360, a haptic interface 362, an optional global positioning systems (GPS) receiver 364 and a camera(s) or other optical, thermal or electromagnetic sensors 366. Device 300 can include one camera/sensor 366, or a plurality of cameras/sensors 366, as understood by those of skill in the art. Power supply 326 provides power to the client device 300.

Client device 300 may optionally communicate with a conventional base station (not shown), or directly with another computing device. Network interface 350 is sometimes known as a transceiver, transceiving device, or network interface card (NIC).

In some embodiments, audio interface 352 is arranged to produce and receive audio signals such as the sound of a human voice. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

Keypad 356 may comprise any input device arranged to receive input from a user. Illuminator 358 may provide a status indication and/or provide light.

In some embodiments, client device 300 also comprises input/output interface 360 for communicating with external. Input/output interface 360 can utilize one or more communication technologies, such as USB, infrared, Bluetooth™, or the like. In some embodiments, haptic interface 362 is arranged to provide tactile feedback to a user of the client device.

Optional GPS transceiver 364 can determine the physical coordinates of client device 300 on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS or the like, to further determine the physical location of Client device 300 on the surface of the Earth. In some embodiments, however, the client device 300 may through other components, provide other information that may be employed to determine a physical location of the device, including for example, a MAC address, Internet Protocol (IP) address, or the like.

In some embodiments, mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of client device 300. The mass memory also stores an operating system 341 for controlling the operation of client device 300.

In some embodiments, memory 330 further includes one or more data stores, which can be utilized by client device 300 to store, among other things, applications 342 and/or other information or data. For example, data stores may be employed to store information that describes various capabilities of client device 300. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 300.

In some embodiments, applications 342 may include computer executable instructions which, when executed by client device 300, transmit, receive, and/or otherwise process audio, video, images, and enable telecommunication with a server and/or another user of another client device. In some embodiments, applications 342 may further include search client 345 that is configured to send, to receive, and/or to otherwise process a search query and/or search result.

Having described the components of the general architecture employed within some embodiments, the components' general operation with respect to some embodiments will now be described below.

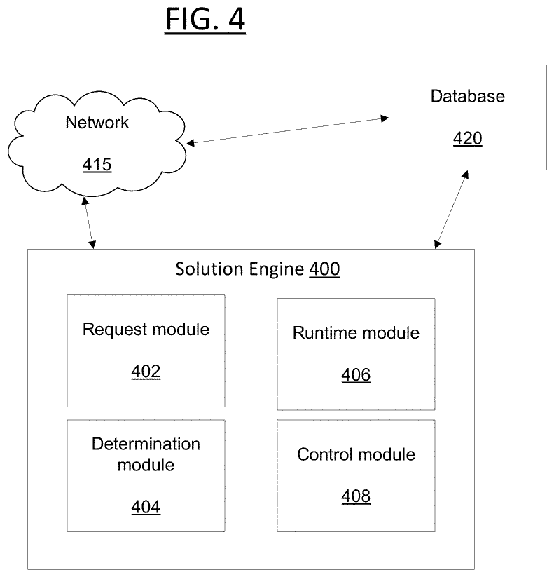

FIG. 4 is a block diagram illustrating the components of some embodiments. FIG. 4 includes solution engine 400, network 415 and database 420. The solution engine 400 can be a special purpose machine or processor and could be hosted by a cloud server (e.g., cloud web services server(s)), application server, content server, web server, search server, content provider, third party server, user's computing device, and the like, or any combination thereof.

According to some embodiments, solution engine 400 can be embodied as a stand-alone application that executes on a server and/or user device (e.g., on a cloud server and/or on-prem on a user device or local storage). In some embodiments, the solution engine 400 can function as an application installed on a device; and, in some embodiments, such application can be a multi-tenant, SaaS web-based application accessed by a device(s) over a network. In some embodiments, engine 400 comprises functionality for integration with a private data center, a SaaS, PaaS, IaaS, and the like.

The database 420 can be any type of database or memory and can be associated with a content server on a network (e.g., cloud server, content server, a search server or application server) or a user's device (e.g., client devices discussed above in FIGS. 1-3). Database 420 comprises a dataset of data and metadata associated with local and/or network information related to users, services, applications, content and the like. Such information can be stored and indexed in the database 420 independently and/or as a linked or associated dataset. As discussed above, it should be understood that the data (and metadata) in the database 420 can be any type of information and type, whether known or to be known, without departing from the scope of the present disclosure.

According to some embodiments, database 420 can store data and metadata associated with users, applications, programs, versions, operations, tasks, assets, files, projects, versions, synchronization events, schedules, images, videos, text, messages, products, items and services from an assortment of media and/or service providers and/or platforms, and the like. It should be understood that the data (and metadata) in the database 420 can be any type of information related to a user, asset, location, job, operation, content, a device, an application, a service provider, a content provider, whether known or to be known, without departing from the scope of the present disclosure.

As discussed above, with reference to FIGS. 1-2, the network 415 can be any type of network such as, but not limited to, a wireless network, a local area network (LAN), wide area network (WAN), the Internet, or a combination thereof. The network 415 facilitates connectivity of the solution engine 400, and the database of stored resources 420. Indeed, as illustrated in FIG. 4, the solution engine 400 and database 420 can be directly connected by any known or to be known method of connecting and/or enabling communication between such devices and resources.

The principal processor, server, or combination of devices that comprises hardware programmed in accordance with the special purpose functions herein is referred to for convenience as solution engine 400, and includes service module 402, runtime module 404, application program interface (API) module 406 and control module 408.

According to some embodiments, request module 402 can be configured for handling requests for solutions and/or identifying information that can be utilized for operation and/or solution option determinations, as discussed below.

In some embodiments, determination module 404 can be configured for determining, deriving, forecasting and/or otherwise identifying types and quantities of operations, applications and files that an entity is requesting and/or needs to perform their identified operations.

In some embodiments, runtime module 406 can be configured to integrate with request module 402, determination module and control module 406 in order to control and/or execute the subscribed operations, file and/or data/metadata provided by engine 400. In some embodiments, modules 404 and 406 can operate as a unified API. In some embodiments, the operations of control module 408 can be included as part of or associated with determination module 408, which can be part of a unified API for modules 404-408.

In some embodiments, runtime module 406 can be further configured to provide services including, but not limited to, an application management service, a subscription management service, a package management service, a type customization service, a privilege management service, a user management service, a rule management service, a resource management service, and a profile management service, and the like, and/or some combination thereof.

In some embodiments, runtime module 406 can be configured to provide a plurality of application program interfaces (APIs) or software development kits (SDKs) for executing different functionalities of engine 400. In some embodiments, APIs may be categorized as APIs on the client side and/or on the service side. In some embodiments, client-side APIs can provide access to the client side services. In some embodiments, server-side APIs can provide access to server-provided services over a network, such as, but not limited to, application and/or file and pricing management, distribution and synchronization, as well as resource (e.g., real-world resources as well as network application resources) availability determinations and dissemination. The service-side APIs can be configured to facilitate access to software components and/or runtime files for execution over a network or via client-side operations.

In some embodiments, control module 408 can be configured for performing operations related to granting access, controlling privileges, initiating synchronization events, launching applications, effectuating installations, providing updates, and the like, or some combination thereof. Control module 408 can dictate different application and/or file deployment options, based on device and/or network configuration and capabilities, as well as subscription details for each device and/or service package.

It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

Turning to FIG. 5, Process 500 provides a non-limiting example data flow for performing embodiments of the disclosed systems and methods. As discussed above and below in more detail, according to some embodiments, the disclosed framework, as provided for in relation to Process 500, operates to achieve faster return-on-investment (ROI) by removing traditional barriers to software adoption via a flexible subscription program.

In some embodiments, the subscription program, referred to as a “subscription solution”, can include, but is not limited to, a mixture of cloud, hybrid and on-premises solutions. These solutions can be applications and/or hosted and/or executable software programs that are affiliated and/or provided by a particular company or are “in-house” (e.g., AVEVA® products), and/or can be provided and/or licensed third party products. As discussed herein, Process 500 enables the selection, subscribing to, usage and monitoring of a set of operational solutions that can be upgraded and/or supported via affiliated services that typically accompany subscribed services.

Thus, according to some embodiments, the disclosed systems and methods provided by engine 400's execution of Process 400 provides users (e.g., clients or other entities) with capabilities to access and utilize a suite of software programs from a defined and/or dynamically determined software portfolio. The programs within the provided solution to a user can be scalable, in that they can initially adhere to a user's current needs, but they can be dynamically and automatically modified based on perceived needs as operations of the user progress or are performed. Thus, real-time data (or substantially real-time data) can be monitored and analyzed to provide users with up-to-date and current solutions that address their current needs.

According to some embodiments, Steps 502-504 can be performed by request module 402 of solution engine 400; Step 506 can be performed by determination module 404; Steps 508-510 can be performed by runtime module 406; and Steps 512-514 can be performed by control module 514.

Some embodiments of Process 500 begin with Step 502 where a request from a user is received. The request can correspond to the user's desire to be provided a suite or set of software solution options. As discussed above, the user can be a third party entity (e.g., a company), and the software solutions can be a set of software applications that are provided by a provider of engine 400 (e.g., AVEVA®, for example).

In some embodiments, the request of Step 502 can indicate the desired solutions that are being requested, or a type of solution(s) being requested. In some embodiments, the request can indicate the needs that are desired to be requested (e.g., “need to perform X, please provide Y that addresses this need”). In some embodiments, the request can also or alternatively provide identifying information related to the user, which can be leveraged by engine 400 to identify which needs are current, which are potentially future needs, and/or which types of programs will be required to address such needs.

In some embodiments, the request can include, but is not limited to, operation data related to the user, which can correspond to a preset period of time of asset or machine operations of the user for a particular job or a set of jobs at a jobsite(s), and the like. This type of data can be analyzed, as discussed below, to determine which solutions are capable of not only addressing and/or executing the type of operations that result in the usage data, but also performing the metrics reflected in the usage data so that the operations of the user can be improved.

In some embodiments, the request can be for software support, software accessibility (e.g., access to products to download and/or execute (e.g., licenses)), software upgrades, and the like, or some combination thereof.

In Step 504, the request (and the information included therein and/or associated therewith, as discussed above) can be analyzed, whereby information related to the identity of options for particular solutions can be identified. Some embodiments of Step 504 therefore enable the identification of which software solutions (e.g., applications) are suggested for the user based on their request.

In some embodiments, the request of Step 502 can be analyzed based on the information included therein, where it can be automatically determined the type, term and availability of solutions for a user. In some embodiments, the analysis of Step 504 can involve engine 400 executing any type of known or to be known computational analysis technique on the request and the data included therein and/or associated therewith, including but not limited to, vector analysis, data mining, computer vision, machine learning, neural network, artificial intelligence, and the like, or some combination thereof.

As a result of Step 504's analysis, a determination of a type of subscription solution for the user is performed by engine 400. According to some embodiments, the type of subscription solution can indicate, but is not limited to, which software applications/products the user needs, a term of usage, rights associated with the usage, quantity of users (e.g., span of the license for the user's employees), and an adjustable cost per usage variable that can correlate to usage, quantity of users and term. In some embodiments, Step 504 can further include the compilation of a subscription data object that outlines within a document object model (DOM) the determined data points of the determined solution for the user. The data object can be configured as a displayable page that can provide deep-linking features to supplemental information related to the suggested products within the subscription solution.

In some embodiments, Step 504 can further include presenting this solution to the user for selection of a set of the recommended solutions. In some embodiments, the selection can include selecting a portion of the solutions, requesting modified version of solutions (e.g., more/less licenses, different versions of applications, different applications, different terms, and the like), rejecting a portion of the solutions, requesting more solutions, and the like. Thus, Step 504 can enable the user to accept and/or reject particular solutions.

In some embodiments, the solution and subscription based/selected therefrom can correspond to a type of “flex” subscription, which can include a plurality of tiers, including, but not limited to, “essential”, “standard”, “professional”, and “premium”, as discussed below. These tiers correspond to a payment amount, availability and/or usage availability of specific types of programs, terms of usage, and the like.

In some embodiments, the determined solutions in Step 504 can be automatically assigned and provided to the user, as the user's request (from Step 502) can indicate an automatic adoption of recommended solutions.

Upon the determination of Step 506, and the adoption by the user, which can be automatically or upon selection and acceptance by the user, the user is enabled to access and execute the software solutions. This can be enabled via Step 508 where a user's account is created (or updated, if they are an existing customer/user), the subscription is assigned (or updated) thereto, and the account includes data objects that enable access to and/or executable functionality for the subscribed solutions, as well as credits, credit portfolios and other flex subscription functionality, as discussed below. As discussed above, the access and/or execution of subscribed solutions can be local (e.g., on-prem) or can be network based where user's access web-based versions of the applications so as to utilize with their own assets (e.g., equipment or machinery) to perform their job-operations.

Process 500 proceeds to Step 510 where engine 400 monitors the usage of the operations of the solutions that the user subscribed to. In some embodiments, such monitoring can be according to a time period, which can occur in real-time (e.g., as data is generated), upon a threshold satisfying set of data being generated, after a predetermined period of time, upon closing an application, upon request by the user and/or system administrator, and the like, or some combination thereof.

In Step 512, the monitored usage data is analyzed. In some embodiments, the usage data that is monitored, collected and/or analyzed can be in accordance with credits and/or credit consumption models that correspond to a type of subscription, a portfolio for a user, and the like, as discussed in more detail below.

In some embodiments, the analysis of in Step 512 can, in a similar manner, be performed according to a time period, as discussed above for Step 510. In some embodiments, the analysis can be performed in a similar manner as discussed above in relation to the computational analysis for Step 504. In some embodiments, the analysis provides data that can indicate how effective the solutions provided to and used by the user are operating, which can be realized via graphs, metrics or other computable data that relates a quantity and quality of operational data of a software program.

In Step 514, engine 400 controls how the operations according to the assigned subscription are performed. In some embodiments, engine 400 determines if updates (or changes) to the subscription are needed based on the analysis of the monitored usage data. Some embodiments of the determination can involve comparing the metrics of the usage data to a threshold that indicates minimum performance level for software solutions. The comparison provides an indication as to whether the user's needs, which can correspond to their asset operation, user operation, supply and/or volume of product operation, and the like, are being met by the solutions that are subscribed to. For example, if a user is executing a drill, and a software program is provided to manage the maintenance and operation of the drill, yet it is failing to catch particular alarms or errors that can cause unsafe work conditions or a reduction in the efficiency of the drill, then this data may indicate that the solution subscribed to needs to be updated or an alternative solution needs to be provided based on the usage of the drill by the user.

In some embodiments, the monitored and analyzed usage data, and the determinations (from Steps 510-514) can be collected and stored in an associated database (e.g., database 420).

In some embodiments, if updates are needed (e.g., the metrics are below the threshold) Process 500 proceeds to Step 506, where a determination of the types of solutions is performed in a similar manner as discussed above. In such embodiments, engine 400's determination of types of solutions can further be based on the determination(s) from Step 514.

In some embodiments, if updates are not determined to be needed (e.g., the solutions are operating with associated metrics at or above the threshold level), then Process 500 proceeds back to Step 510 to continue monitor the usage of the solutions' operations.

In some embodiments, the determination of Step 514 can indicate that the term of subscription is ending (or is proximate to its ending date/time—for example, it expires in n days), then Process 500 can proceed back to Step 506, where the usage data collected and analyzed in Steps 510-512 can be used as a basis for Step 506's determination.

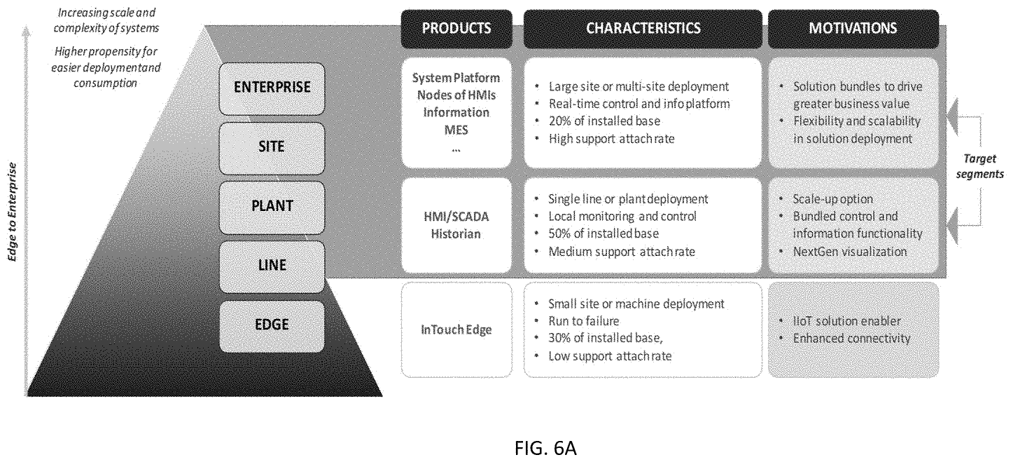

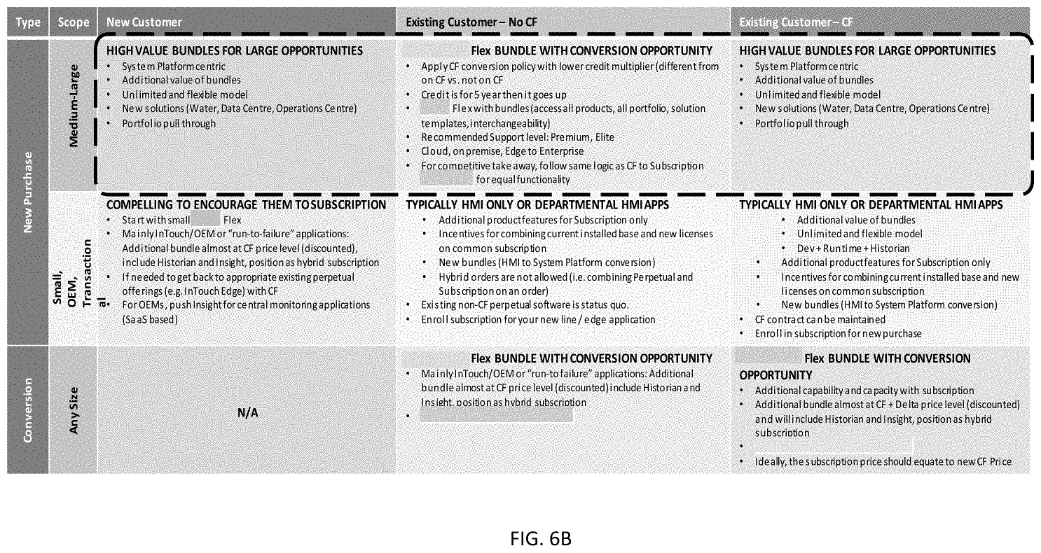

Turning to FIGS. 6A-22, each figure provides a non-limiting example embodiment of the usage, impact and/or functionality of the framework's operation as discussed above in relation to FIG. 5.

In FIG. 6A, some embodiments of the disclosed systems and methods described herein can comprise a subscription program useful for users (e.g., small, medium or large-sized customers) who want flexibility in procurement and use of AVEVA® brand software to drive digital transformation. In some embodiments, the framework provides commercial flexibility that enables customers to build to benefits not limited or defined by budgets, and to expand capability from the outset of a project with access to more solutions. In some embodiments, the framework can eliminate capital expenditure requests, and enables the use of operating budgets for a “pay-as-you-need” financing.

Further, some embodiments of the framework include flexible architectures covering on-premise, cloud and hybrid, under perpetual and subscription licensing terms and delivering investment security. Such systems offer additional flexibility for customers and utilize market-leading industrial automation software portfolios. Some embodiments include a common subscription framework to achieve competitive disruption, and offering a compelling subscription offer to capture and retain long-term revenue. In some embodiments, the system can reduce quoting and ordering complexity, but deliver more than just a new financial approach. For example, in some embodiments, the system can drive closer customer engagement and capitalize on new revenue opportunities.

FIG. 6B illustrates user personas, profiles and associated product implementations according to some embodiments of the present disclosure. Some embodiments include a framework of digital transformation enhancing supply chain management, providing engineering efficiency, asset optimization, cost reduction, production quality improvement, downtime elimination, information communication across all coupled systems, and process, monitor, and control functions. In some embodiments, the system provides flexibility to implement solutions and architectures across a variety of industries. In some embodiments, the system provides the flexibility to monitor and operate your industrial system from a variety of devices and platforms. In some embodiments, implementations include new purchases by existing or new customers, upgrades by existing customers, and/or conversions by existing customers.

In some further embodiments, the framework provides the flexibility to accelerate transformation with access to AVEVA Group plc's complete industrial software portfolio of edge to enterprise solutions & cloud capabilities. In some embodiments, the system enables all common architectures, and combinations with a single offer, and provides cloud, on-premise and hybrid architectures at all phases in a project lifecycle.

In some embodiments, the framework provides the flexibility to grow a system as business needs grow, without disrupting operations. In some embodiments, the system provides the flexibility to adjust usage and data points as needs change, and enables management, distribution and compliance of all software asset entitlements.

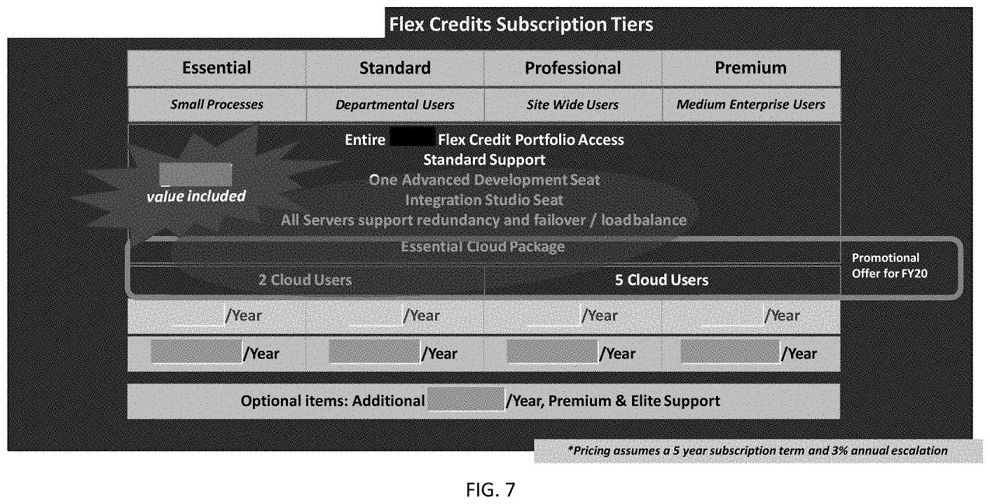

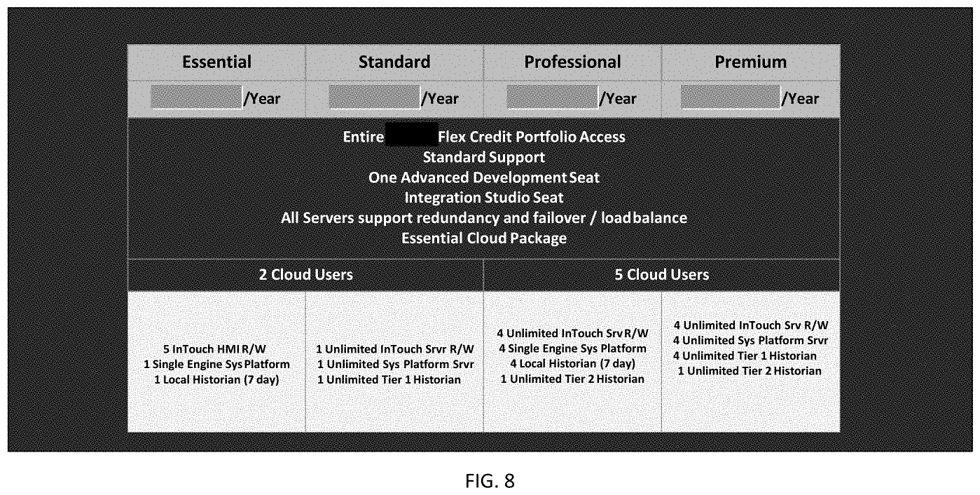

FIG. 7 illustrates a non-limiting embodiment of a flex credit subscription framework in accordance with some embodiments of the present disclosure. In some embodiments, the flex credit system can include a plurality of tiers, including, but not limited to, “essential”, “standard”, “professional”, and “premium”, as discussed above. As shown in FIG. 8, illustrating subscription tier details in accordance with some embodiments of the present disclosure, in some embodiments, each subscription tier can include different levels of equipment and/or service functionality.

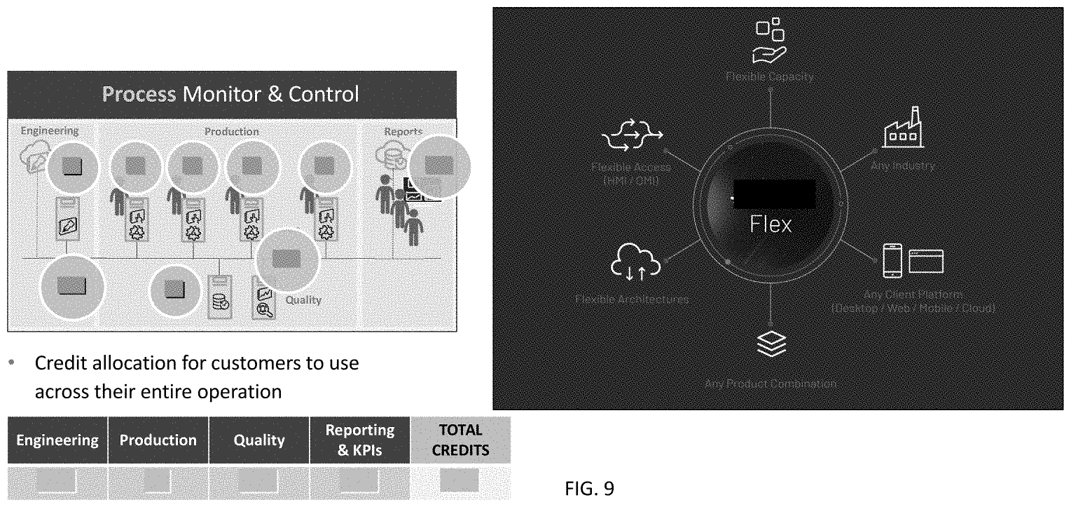

As shown in FIG. 9, illustrating an example of flex credit use in accordance with some embodiments of the present disclosure, in some embodiments, credits can be distributed across an operation, including engineering, production, quality, and reporting. In some embodiments, credits can be used as tracking system to detect usage, which can provide the metrics related to the usage data being monitored and analyzed, as discussed above.

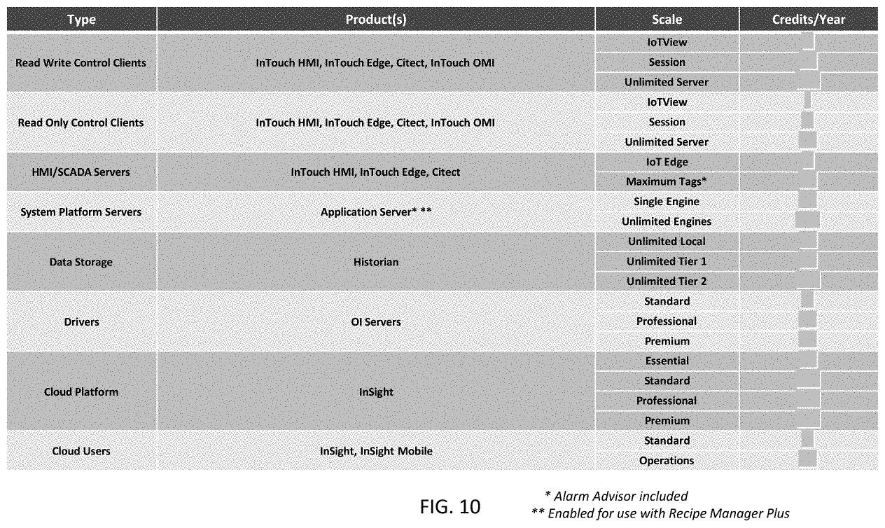

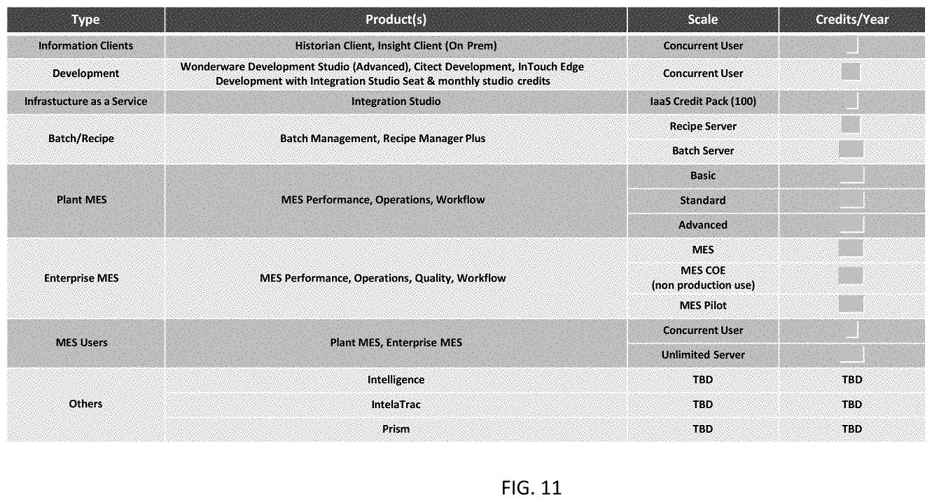

FIGS. 10-11 illustrate flex credit portfolios in accordance with some embodiments of the present disclosure. In some embodiments, credits can be applied to various functions or aspects of the system. For example, some embodiments include allocation of credit by equipment type and product, and can include variable credit scale (quantity) and credits based on time (e.g., such as a year). The framework can provide multiple methods for users to implement a direct subscription into an account. For example, some embodiments include subscription access including product-centric offerings that can be made available in 1, 3, or 5-year terms. Some embodiments include standard support with every subscription with premium or elite support also being available.

In some embodiments, users can select a subscription via a subscriptions configurator that can precisely configure the product size needed (e.g., as discussed above in relation to Steps 504-506, above). In some embodiments, this can be useful if the customer is only focused on specific products with a limited budget. Some further embodiments include flex credits that can be project and/or site specific, and the credits can be enabled for an entire portfolio. In some embodiments, the flex credits can be available in 1, 3 or 5-year terms, with standard support included with every subscription (with premium or elite support also available), and where users can subscribe to consumable credits that can be redeemed for product licenses.

In some embodiments, users can activate or deactivate licenses as needed and morph usage across the portfolio as needs evolve. Some embodiments include a customer success manager (CSM). In some embodiments, the flex credits are “all you can eat” for a term and then a true-up occurs. In some embodiments, the flex credits are restricted to a set of named sites and a limited set of products. In some embodiments, the flex credits include cloud fees and third party royalty costs are not included. In other embodiments, cloud fees are bundled. In some further embodiments, third party royalty costs are bundled.

Some embodiments are built into an existing global customer support portal, either with or without updates or modifications to the existing systems. Some embodiments enable customers and their distributors to see consumption of credits to date and projected consumption given current licensing. Some embodiments can enable distributors to claim and download licenses using credits, and deactivate previously claimed licenses on behalf of a given customer. In some embodiments, claimed licenses are fulfilled by a manual license creation and upload process. Some embodiments enable immediate, automatic generation and download of requested licenses in a global customer support portal upon a valid license claim.

Some embodiments include an annual allotment of credits over a subscription term built on a monthly credit consumption model. In some embodiments, the system offers standard terms that include the subscription cancellable with penalty. In some embodiments, the credits subscriptions are on a single customer/site basis, and the offering can include forms of all channel products, both on-premises licensing and service offerings, such as, for example, SaaS offerings. In some embodiments, the credit offerings are a lead into cloud offerings, and in some embodiments, AVEVA® InSight licenses can be included with each tier. Some embodiments include new functionalities only available via certain service provider's such as through AVEVA® flex credits.

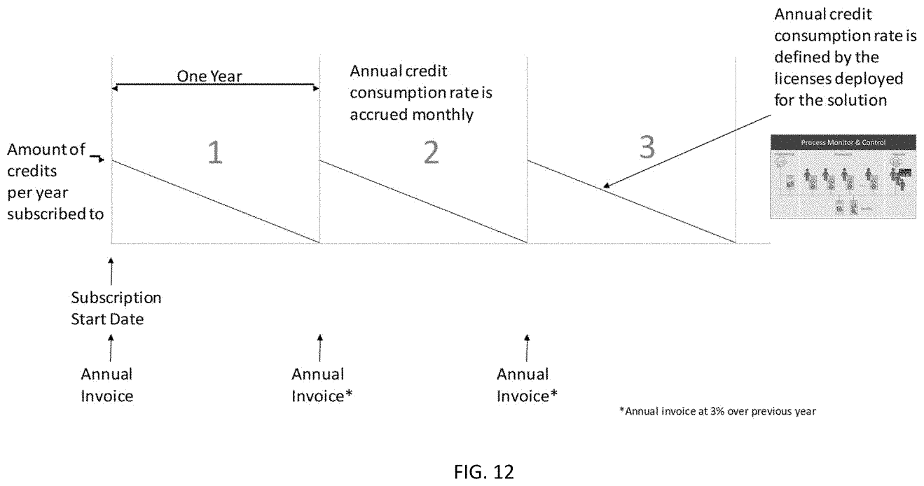

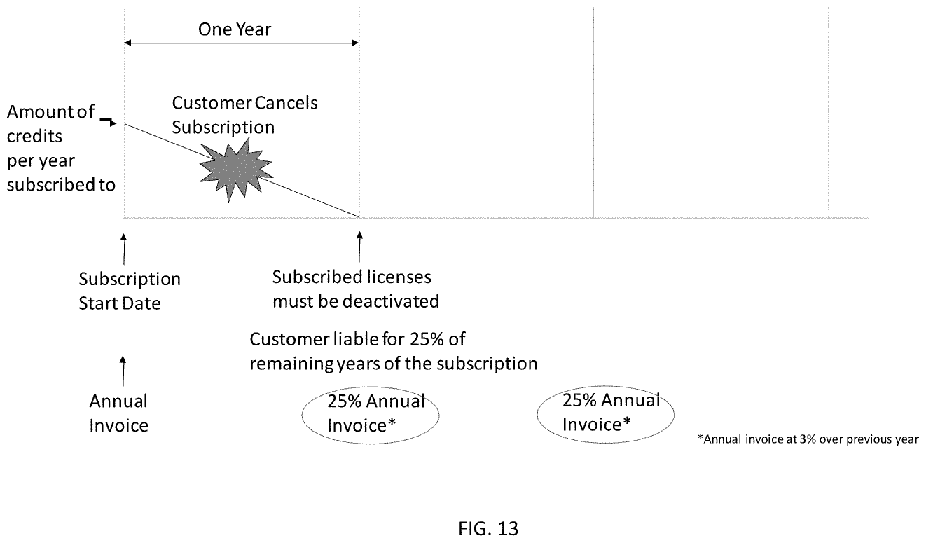

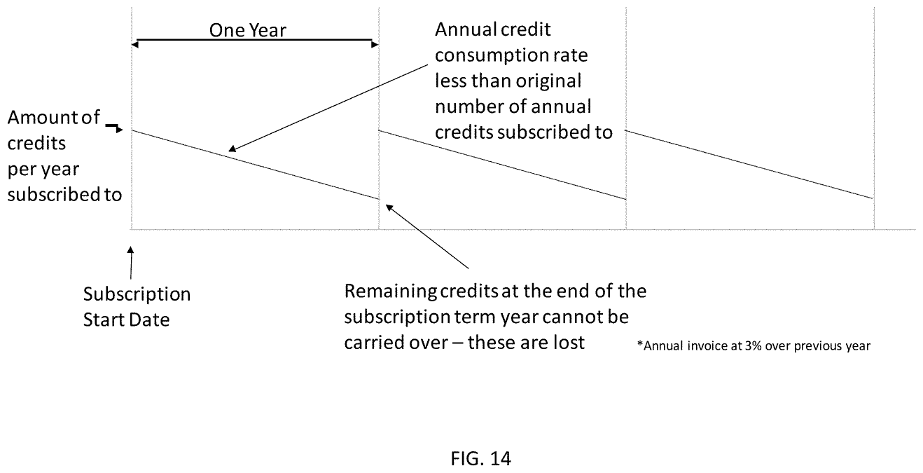

FIGS. 12-16 illustrates non-limiting examples of credit consumption models in accordance with some embodiments of the present disclosure. For example, FIG. 12 shows a three-year credit subscription example, and illustrates credit consumption defined by licenses deployed. FIG. 13 shows an example of an annual credit consumption using an example where a customer cancels a subscription during a year. In this instance, the customer is liable for 25% of the remaining year's subscription. FIG. 14 shows an example of an end of term excess based on a credit consumption being fewer than the number of subscribed credits. In this instance, the credits are lost at the end of a term year.

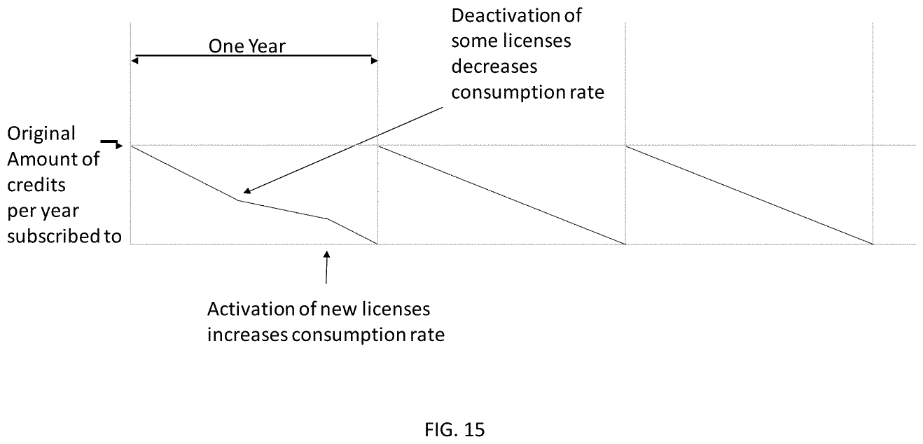

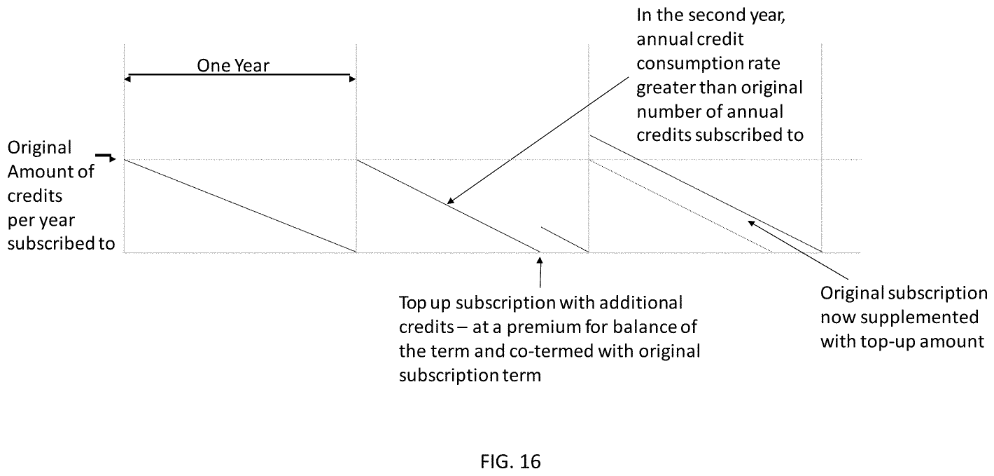

In some embodiments, at least some of the credits or partial credits can carry over to at least one further term year or partial year. FIG. 15 shows an example of deactivation/activation of licenses during term year. In some embodiments, deactivation of some licenses decreases consumption rate, and activation of licenses increases consumption rate. FIG. 16 shows a top-up credit example where credits can be added or “topped-up” at any point during a term period.

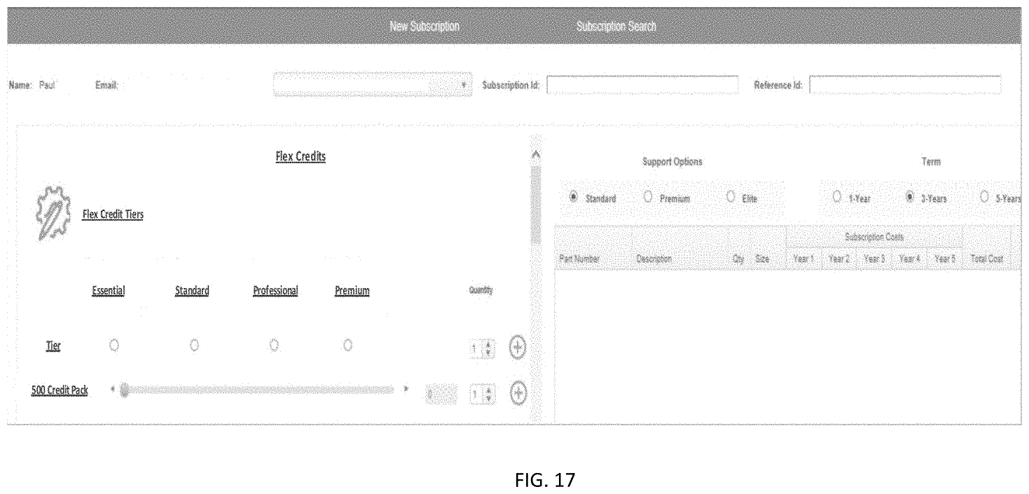

FIG. 17 illustrates a quote and ordering subscription display in accordance with some embodiments of the present disclosure. Some embodiments include an online portal display page for quote and ordering including a subscription display as shown. Some embodiments of FIG. 17 can be utilized when a user provides a request for solutions and/or selects the solution options presented to them (as discussed above in relation to Steps 502 and 506, discussed above).

Note, Wonderware® and the Wonderware® logo are registered trademarks owned by AVEVA Group plc.; and AVEVA® product/software names are trademarks or registered trademarks of AVEVA Group plc or its subsidiaries. It should be understood that these are non-limiting examples of products and/or functionality that can be provided as a means for subscriptions functionality to be provided for a user/customer.

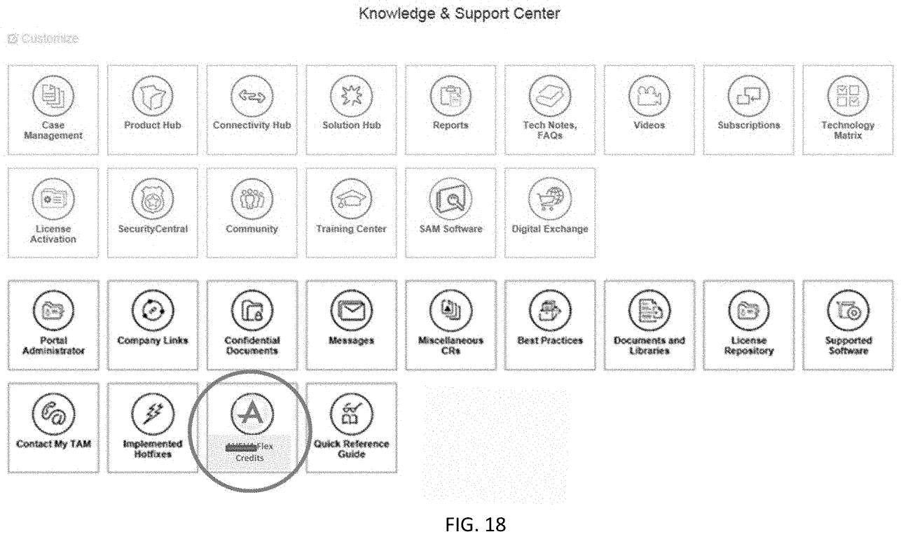

FIG. 18 illustrates a non-limiting example of a support portal in accordance with some embodiments of the present disclosure. In some embodiments, the support portal can enable users to manage flex credits (e.g., such as AVEVA® flex credits) in global customer support portal, activate/deactivate licenses, and manage credit consumption.

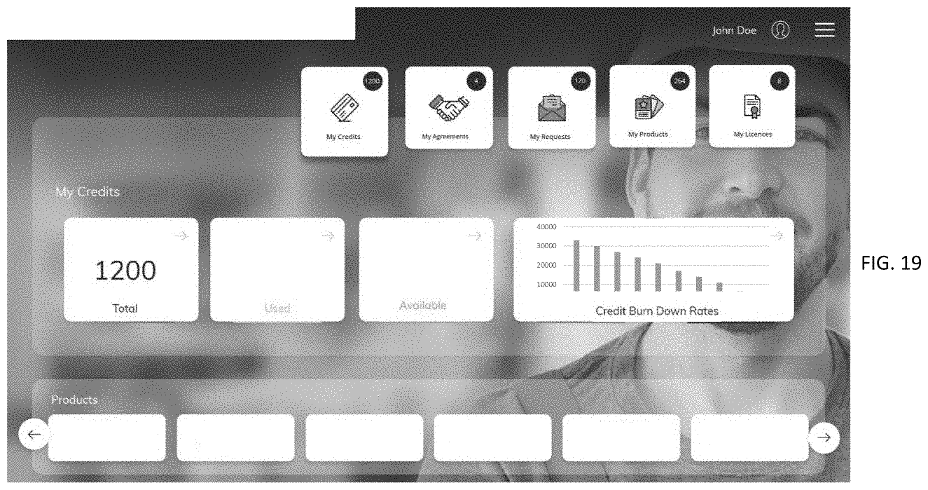

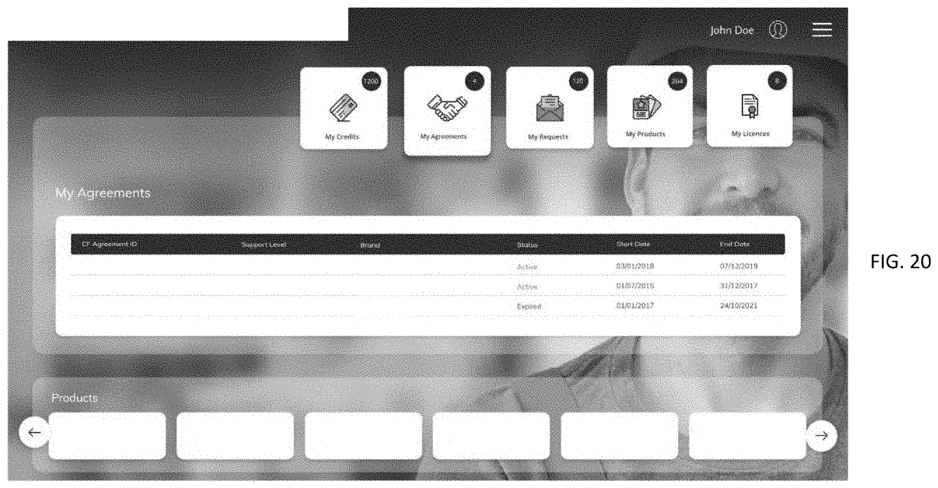

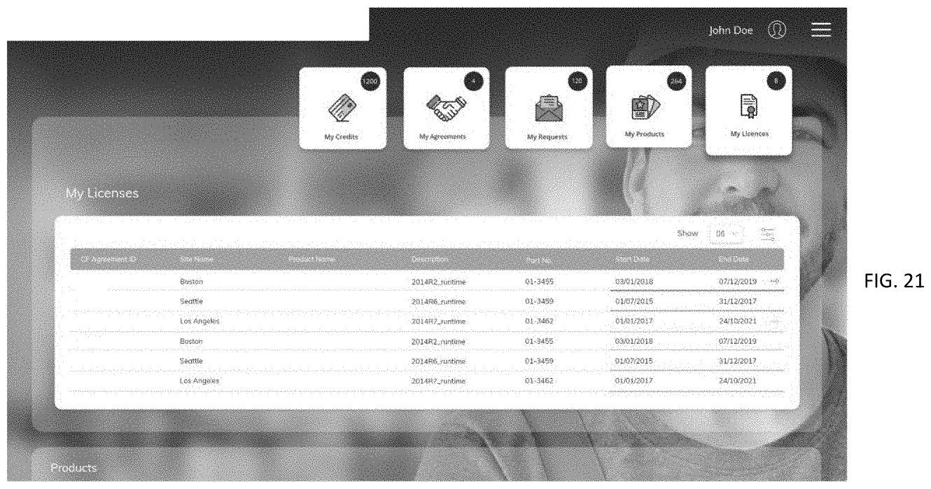

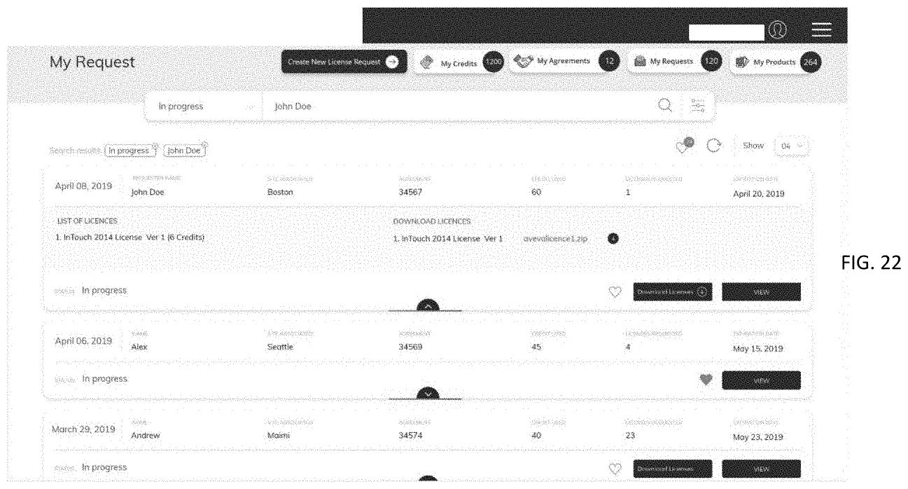

FIGS. 19-17 illustrate non-limiting examples of flex credits management displays in accordance with some embodiments of the present disclosure. For example, FIG. 19 shows a credit management display enabling users to manage flex credits, and enable channel partners and customers to monitor usage and projected consumption. FIG. 20 shows a credit management display enabling users including channel partners and customers to view subscription agreements. FIG. 21 shows a credit management display enabling users to monitor products licenses deployed against credits. Finally, FIG. 22 shows a credit management display enabling users to request and download product licenses on behalf of customers.

Any of the operations described herein that form part of the present disclosure are useful machine operations. The present disclosure also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

Some embodiments can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A method comprising:
receiving, over a network by a device, a request from a user, the request comprising information related to a set of assets operational by the user in relation to at least one jobsite;
analyzing, by the device, the request, and identifying a set of software solutions for the user, the software solutions comprising executable software applications provided by the device;
determining, by the device, based on the identified set of software solutions, a type of subscription for the user, the type of subscription comprising information controlling a manner that the user can access and execute each software solution;
assigning, by the device, a subscription to an account of the user based on the type of subscription;
monitoring, over the network by the device, execution of each software solution, and identifying usage data related to operations performed via at least a portion of the set of software solutions in accordance with the subscription;
analyzing, by the device, the identified usage data; and
controlling, by the device over the network, the operations performed by the user based on the analysis of the identified usage data.

2. The method of claim 1, further comprising;
determining, based on the analysis of the identified usage data, that modifications to the subscription are required; and
modifying the assigned subscription based on the identified usage data and the modification determination, wherein the control of the operations is based on the modified subscription.

3. The method of claim 2, wherein the determination that the modifications to the subscription are required comprises determining that the operations performed via at least a portion of the set of software solutions in accordance with the subscription are not satisfying a performance level threshold of at least one of the set of assets.

4. The method of claim 1, further comprising:
presenting a page comprising information related to the type of subscription to the user;
receiving input from the user related to the presented information; and
determining the subscription based on the received input, wherein the assigned subscription is the determined subscription.

5. The method of claim 1, further comprising:
identifying that the request indicated an automatic indication of a subscription assignment; and
automatically performing the assigning without user input.

6. The method of claim 1, wherein the subscription assigned to an account of the user comprises information selected from a group consisting of: a term, credits, credit portfolio, user data, usage data, usage data determinations, and type of subscription, software application information.

7. The method of claim 1, wherein the monitoring and analysis of the usage of the software solutions comprises collecting and storing information related to the usage in an associated database.

8. The method of claim 1, wherein the user is a third party entity

9. A device comprising:
a processor configured to:
receive, over a network, a request from a user, the request comprising information related to a set of assets operational by the user in relation to at least one jobsite;
analyze, the request, and identify a set of software solutions for the user, the software solutions comprising executable software applications provided by the device;
determine, based on the identified set of software solutions, a type of subscription for the user, the type of subscription comprising information controlling a manner that the user can access and execute each software solution;
assign a subscription to an account of the user based on the type of subscription;
monitor, over the network by the device, execution of each software solution, and identify usage data related to operations performed via at least a portion of the set of software solutions in accordance with the subscription;
analyze the identified usage data; and
control, over the network, the operations performed by the user based on the analysis of the identified usage data.

10. The device of claim 9, further comprising;
determine, based on the analysis of the identified usage data, that modifications to the subscription are required; and
modify the assigned subscription based on the identified usage data and the modification determination, wherein the control of the operations is based on the modified subscription.

11. The device of claim 10, wherein the determination that the modifications to the subscription are required comprises determining that the operations performed via at least a portion of the set of software solutions in accordance with the subscription are not satisfying a performance level threshold of at least one of the set of assets.

12. The device of claim 9, further comprising:
presenting a page comprising information related to the type of subscription to the user;
receiving input from the user related to the presented information; and
determining the subscription based on the received input, wherein the assigned subscription is the determined subscription.

13. The device of claim 9, further comprising:
identifying that the request indicated an automatic indication of a subscription assignment; and
automatically performing the assigning without user input.

14. The device of claim 9, wherein the subscription assigned to an account of the user comprises information selected from a group consisting of: a term, credits, credit portfolio, user data, usage data, usage data determinations, and type of subscription, software application information.

15. The device of claim 9, wherein the monitoring and analysis of the usage of the software solutions comprises collecting and storing information related to the usage in an associated database.

16. A non-transitory computer-readable storage medium tangibly encoded with computer-executable instructions, that when executed by a processor associated with a device, performs a method comprising:
receiving, over a network by the device, a request from a user, the request comprising information related to a set of assets operational by the user in relation to at least one jobsite;
analyzing, by the device, the request, and identifying a set of software solutions for the user, the software solutions comprising executable software applications provided by the device;
determining, by the device, based on the identified set of software solutions, a type of subscription for the user, the type of subscription comprising information controlling a manner that the user can access and execute each software solution;
assigning, by the device, a subscription to an account of the user based on the type of subscription;
monitoring, over the network by the device, execution of each software solution, and identifying usage data related to operations performed via at least a portion of the set of software solutions in accordance with the subscription;
analyzing, by the device, the identified usage data; and
controlling, by the device over the network, the operations performed by the user based on the analysis of the identified usage data.

17. The non-transitory computer-readable storage medium of claim 16, further comprising;
determining, based on the analysis of the identified usage data, that modifications to the subscription are required; and
modifying the assigned subscription based on the identified usage data and the modification determination, wherein the control of the operations is based on the modified subscription.

18. The non-transitory computer-readable storage medium of claim 17, wherein the determination that the modifications to the subscription are required comprises determining that the operations performed via at least a portion of the set of software solutions in accordance with the subscription are not satisfying a performance level threshold of at least one of the set of assets.

19. The non-transitory computer-readable storage medium of claim 16, further comprising:
presenting a page comprising information related to the type of subscription to the user;
receiving input from the user related to the presented information; and
determining the subscription based on the received input, wherein the assigned subscription is the determined subscription.

20. The non-transitory computer-readable storage medium of claim 16, further comprising:
identifying that the request indicated an automatic indication of a subscription assignment; and
automatically performing the assigning without user input.
